(19) United States
(12) Patent Application Publication
(10) Pub. No.: US 2004/0188489 A1
(43) Pub. Date: Sep. 30, 2004

(54) Power actuated gun with automatic firing

(76) Inventor: Alfonso Losada, Bridgeport, CT (US)

Correspondence Address: JAMES R. CYPHER, 405 14TH STREET, SUITE 1607, OAKLAND, CA, 94612

(21) Appl. No.: 10/687,680

(22) Filed: Oct. 17, 2003

Related U.S. Application Data
(60) Provisional application No. 60/419,768, filed on Oct. 18, 2002.

(51) Int. Cl. B25C 1/14

(52) U.S. Cl. 227/10; 227/18

(57) ABSTRACT

An automated power actuated gun, and a method of using the power actuated gun, the gun being able to drive a fastener assembly having a plate frictionally engaging a nail or stud by means of a trigger firing mechanism that allows the gun to be fired by the use of relative motion between a barrel portion of the gun and the trigger of the gun. The automated power actuated gun can also have attached thereto a fastener feeding track capable of carrying multiple fastener assemblies, and the plates of the fastener assemblies are curved or have grooves and the track is formed for mating engagement with the curved plate for allowing the guiding of the fastener assembly along the track.

### BACKGROUND OF THE INVENTION

This application claims the benefit of U.S. Provisional Application No. 60/419,768, filed Oct. 18, 2002.

Power actuated guns are used in many industrial applications, and particularly construction applications. A power actuated gun is often used to drive a fastener into a relatively hard substrate, such as concrete. The power actuated gun is typically powered by an explosive charge.

Often, with power actuated guns, a fastener is used having a nail frictionally retained in a shaped washer or plate, often called a fastener assembly. Often, an angled plate having a hole therein is used so that a wire or other device can be fastened thereto. One such fastener assembly is disclosed in U.S. Pat. No. 4,736,923 entitled “Fastener Assembly”, issued to Alfonso Losada on Apr. 12, 1988. U.S. Pat. No. 4,736,923 is incorporated herein by reference.

Fastener assemblies having a nail frictionally retained in a washer or plate are generally available loosely packed. With most power actuated guns driving fastener assemblies of this type, the fastener assemblies are placed into the barrel of the gun individually by hand. This can be time consuming.

U.S. Pat. Nos. 6,273,316 and 6,481,611, also granted to Alfonso Losada, teach a fastener feeding track and system for automatically feeding fastener assemblies having a nail frictionally retained in a washer or plate into the barrel of the power actuated gun. U.S. Pat. No. 6,273,316, granted to Alfonso Losada, on Aug. 14, 2001, is incorporated herein by reference.

The use of fastener feeding systems is especially helpful for driving fasteners into ceilings areas that are hard to reach from the ground or floor. In use, the fastener assembly is placed within or partially within the barrel of the power actuated gun and placed adjacent the surface into which the nail of the fastener assembly will be driven. The surface is generally a hard surface which requires the use of the power actuated gun. The power actuated gun is then fired, driving the stud or nail into the hard surface. The fastener feeding system then loads another fastener assembly into the barrel or at least partially into the barrel so that it is ready for firing.

For ceiling applications, the power actuated gun is often placed on a pole with a fastener assembly received within or partially within the bore of the barrel of the gun and the whole device is raised to the ceiling with a pole. When the fastener assembly lies adjacent and in contact with the ceiling where it is to be driven the gun is fired and the nail or stud of the fastener assembly is driven. Because the power actuated gun is placed on a pole, this means it is often removed from the reach of the operator. Having the fastener feeding track attached to the power actuated gun means the user does not have to lower the pole to load the next fastener assembly; however there must be some way for the user to actuate the gun from below.

The present invention teaches a method for actuating the trigger of power actuated gun just by putting pressure on the pole carrying the gun. A number of other systems have been devised by the inventor of the present invention for improving the fasteners used with power actuated guns, the operation of automatically loading fastener assemblies into the barrel of a power actuated gun and the firing the gun. Some of these inventions are described in U.S. patent application Ser. No. 09/729,389, filed Dec. 4, 2000, by Alfonso Losada, entitled “Power Actuated Fastener System”, which is herein incorporated by reference. Some of these inventions are also described in U.S. patent application Ser. No. 10/043,669, filed Jan. 11, 2002, entitled “Fastener Assembly having Grooves for use with a Power Actuated Gun”, filed by Alfonso Losada, which is herein incorporated by reference.

The present invention also teaches an improved method for guiding fastener assemblies in the track to prevent jamming of the fastener assemblies in the track.

The present invention aims to increase worker productivity, allowing workers to install more fastener assemblies in a a safe and accurate manner. Worker productivity is a key economic factor in the construction industry where labor is a larger portion of the cost of any structure, and labor costs continue to rise.

### SUMMARY OF THE INVENTION

One aspect of the present invention is a method of driving a fastener a fastener assembly wherein a laborer performs the steps of positioning a first fastener assembly having a nail frictionally received within a plate over the barrel portion of a power actuated gun, depressing the barrel portion so that a trigger firing mechanism operatively connected to the barrel portion is lowered to contact a trigger of the power actuated gun, and further depressing the barrel portion of the power actuated gun so that trigger firing mechanism releases and pushes on the trigger of the power actuated gun, actuated the gun to drive the nail of the fastener assembly.

Another aspect of the present invention is a a method of driving a fastener a fastener assembly wherein a laborer performs the steps of positioning a first fastener assembly having a nail frictionally received within a plate over the barrel portion of a power actuated gun, and depressing the barrel portion so that a trigger firing mechanism operatively connected to the barrel portion is lowered to contact a trigger of the power actuated gun, the trigger firing mechanism containing means for releasing upon contact with the trigger to fire the power actuated gun.

Another aspect of the present invention is a a method of driving a fastener a fastener assembly wherein a laborer performs the steps of positioning a first fastener assembly having a nail frictionally received within a plate over the barrel portion of a power actuated gun, the power actuated gun having a trigger firing mechanism, the trigger firing mechanism having a pressure member that provides a slight constant pressure to the trigger by means of a spring, and depressing the barrel portion so that the trigger firing mechanism operatively connected to the barrel portion is lowered and applies sufficient pressure to a trigger of the power actuated gun to fire the power actuated gun.

Another aspect of the present invention is a power actuated gun, wherein the gun has a barrel portion which has a trigger firing mechanism, and a trigger, the trigger firing mechanism being operatively connected to the barrel portion so that when the barrel portion is lowered it contacts the trigger of the power actuated gun; actuating the power actuated gun.

Another aspect of the present invention is a fastener assembly feeding system for use with a power actuated gun, the system having a fastener assembly having a curved plate, and a stud frictionally held within the plate, a track adapted to receive the curved plate, the track shaped to conform with the curved shape of the plate, and whereby a plurality of fastener assemblies are guided along the track. The plate can be formed with one or more grooves and or extending portions and the track can be shaped to conform with the groove or grooves or the extending portions of the plate.

Another aspect of the present invention is a fastener assembly feeding system for use with a power actuated gun, the system having a fastener assembly having a plate, the plate having a groove formed within the plate, and a stud frictionally held within the plate, and a track adapted to receive the plate, the track shaped to contact at least one side of the plate only in the groove, whereby a plurality of fastener assemblies are guided along the track. The plate can be shaped with a pair of grooves.

In the present invention, the trigger firing mechanism can be attached directly to the barrel portion of the power actuated gun.

Also, in the present invention, a fastener feeding track can be attached to the barrel portion of the gun, the fastener feeding track carrying a plurality of the fastener assemblies, and the trigger firing mechanism can be attached directly to the fastener feeding track.

Also in the present invention, the power actuated gun can have a spring that biases the barrel portion and track upward away from trigger of the power actuated gun, and when the barrel portion is depressed the spring compresses and the trigger firing mechanism is lowered to contact the trigger.

Also, in the present invention, the trigger firing mechanism can be formed with a threaded member that allows for adjustment of the trigger firing mechanism.

In one embodiment of the present invention, a feeding system for use with a power actuated gun comprises a track to hold a plurality of fastener assemblies which loads those fastener assemblies sequentially into the barrel of the gun, and relative movement between the power actuated gun and an attachment is used to control the operation of the gun. Specifically, the attachment controls the firing of the gun. The relative movement is used to activate a trigger so as to fire the power actuated gun when the fastener assembly is in position.

Accordingly, it is an object of the present invention to make laborers or workers more productive and thereby reduce construction costs.

It is another object of the present invention to provide a power actuated fastening system that has a smooth operation and is easy to use.

It is a further object of the present invention to use the relative movement between the power actuated gun and an attachment to automate the firing of the gun.

It is a further object of the present invention to provide a power actuated fastener system that is safe to use.

It is an advantage of the present system that it saves time.

### BRIEF DESCRIPTION OF THE DRAWINGS

FIG. 1 is a perspective view of an embodiment of the present invention.

FIG. 2 is a side elevation view of an embodiment of the present invention.

FIG. 3 is a blown up view of an embodiment of the present invention.

FIG. 4 is a side elevation view of an embodiment of the present invention.

FIG. 5 is a side elevation view of an embodiment of the present invention.

FIG. 6 is a perspective view of an embodiment of the present invention.

FIG. 7 is a perspective view of a fastener assembly for use with the present invention.

FIG. 8 is a cross-sectional end view of an embodiment of the present invention.

FIG. 9 is a cross-sectional end view of an alternate embodiment of the present invention.

### DETAILED DESCRIPTION OF THE INVENTION

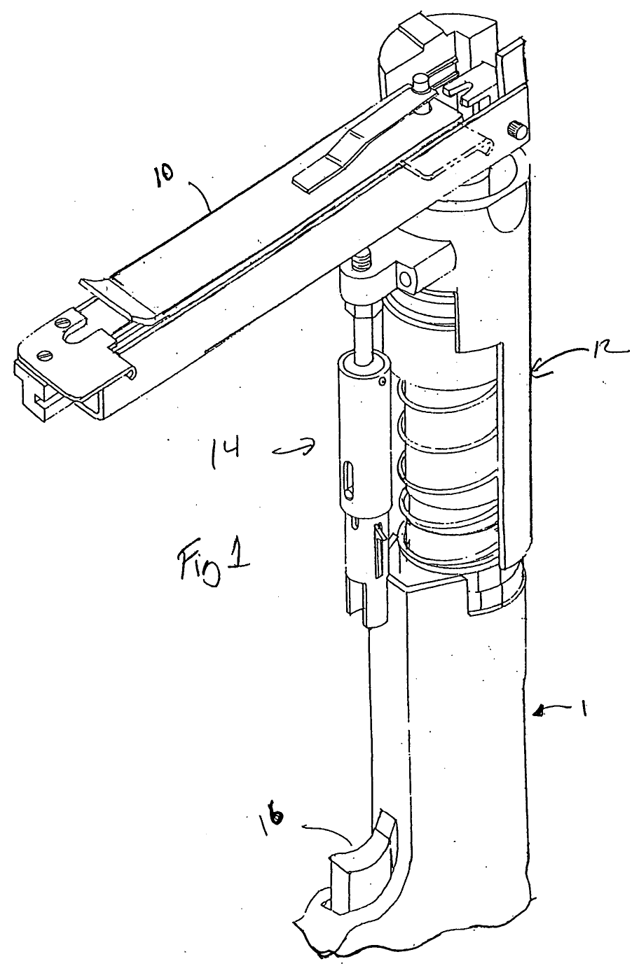

FIG. 1 illustrates a power actuated gun 1 having a track 10 thereon affixed to a barrel portion 12 of the power actuated gun 1. Also attached to barrel portion 12 is a trigger firing mechanism 14. The trigger firing mechanism 14 is positioned over a trigger 16 of the power actuated gun 1.

The track 10 contains a supply of fastener assemblies 20. Each fastener assembly 20, as shown in FIG. 6 has a plate 24 and a nail 25 for being driven with the power actuated gun 1. Upon depressing the barrel portion 12, the trigger firing mechanism 14 is lowered to contact the trigger 16. At a predetermined point, the trigger firing mechanism 14 releases, pushing on trigger 16 firing the power actuated gun 1 and driving the nail 25 of the fastener assembly 20 into a substrate. The sequence is repeated and a fastener assembly 20 within track 10 is advanced.

The trigger firing mechanism 14 is illustrated attached to the barrel portion 12, but may also be attached to the track 10. The trigger firing mechanism 14 may contain any means for releasing upon contact with the trigger 16 to fire the power actuated gun. Additionally, the trigger firing mechanism 14 may be used on a power actuated gun without a track 10.

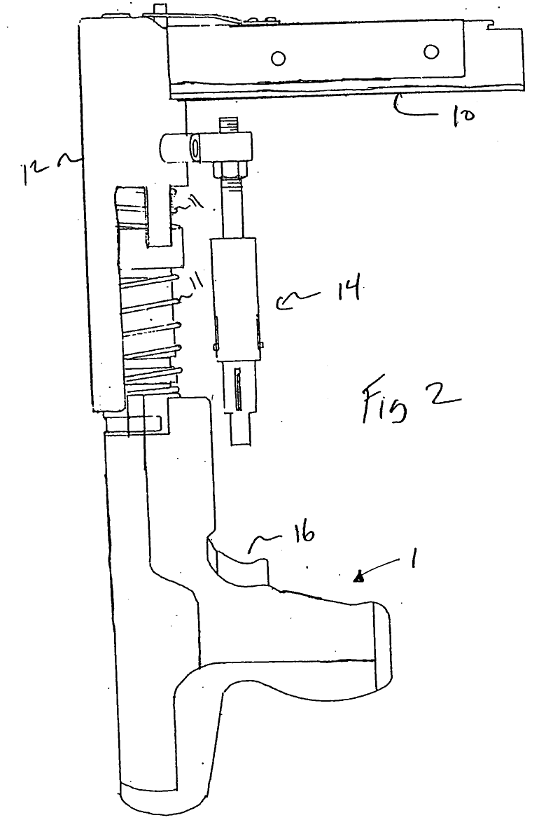

FIG. 2 is another view of the power actuated gun 1 with the trigger firing mechanism 14 in position ready to be lowered and to contact trigger 16. A spring 11 biases the barrel portion 12 and track 10 upward. When the barrel portion 12 contacts a surface the spring 11 compresses and the trigger firing mechanism 14 is lowered to contact the trigger 16.

FIG. 3 is an exploded view illustrating the assembly of the power actuated fun and trigger firing mechanism 14 illustrated in FIG. 2. The trigger firing mechanism 14 may be adjusted by threaded member 17.

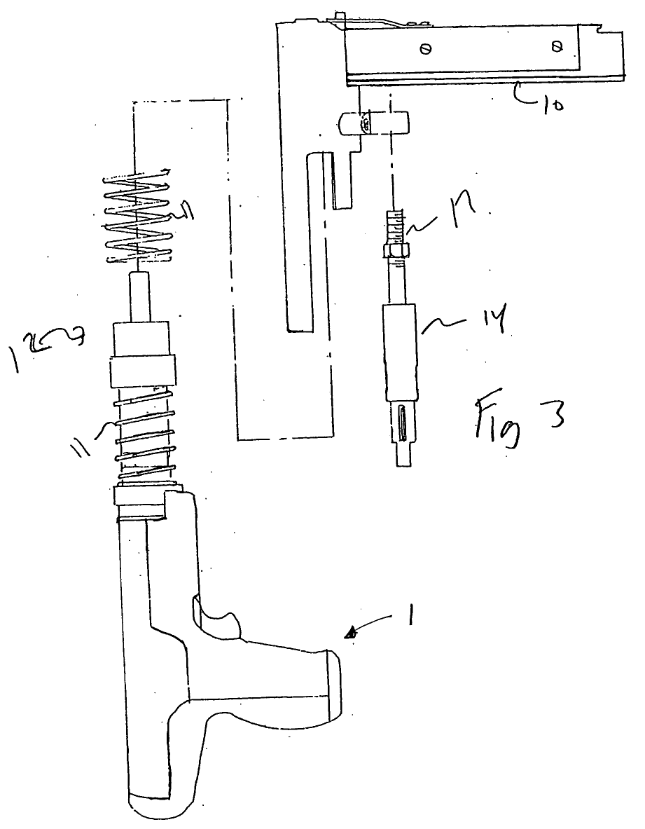

FIG. 4 is another type of trigger firing mechanism 114, the pressure member 118 provides a slight constant pressure to the trigger 16. The pressure member 118 has a spring therein that only places a slight pressure on the trigger 16. This pressure is sufficient to depress slightly the trigger 16 without firing the power actuated gun 1. When the barrel portion 12 is depressed sufficiently such that the gun 1 is in a firing position, the trigger mechanism 114 applies sufficient pressure to the trigger 16 to permit the gun 1 to fire. This embodiment may be used on a power actuated gun 1 that has a safety feature preventing firing unless a slight pressure is applied to the trigger 16.

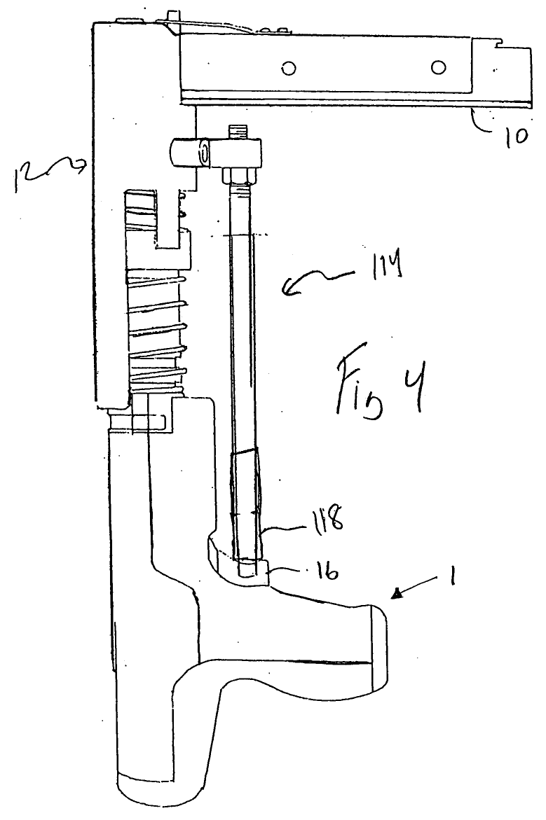

FIG. 5 illustrates another trigger firing mechanism 214. This mechanism lowers with the barrel portion 12 and contacts the trigger 16 so as to fire the power actuated gun 1. The travel distance may be preset or made adjustable so that the power actuated gun 1 will fire when the fastener assembly 20 is in position.

The trigger firing mechanisms illustrated in the various embodiments may all be placed internally within the power actuated gun or covered by a housing. Additionally, each embodiment may be attached to the track 10 rather than the barrel portion 12.

FIG. 6 illustrates a fastener assembly 20 having a plate 24 with a nail or stud 25 therein, and a leg 26 attached to the plate. A wire 28 is shown attached to the leg 26. The fastener assembly 20 is curved with a shape similar to track 110 in which the fastener assembly 20 slides. The track 110 is a fastener assembly feeding track 110 and is illustrated as element number 10 in FIGS. 1-5. The track 110 is shaped to mate or conform with the shape of the fastener assembly 20.

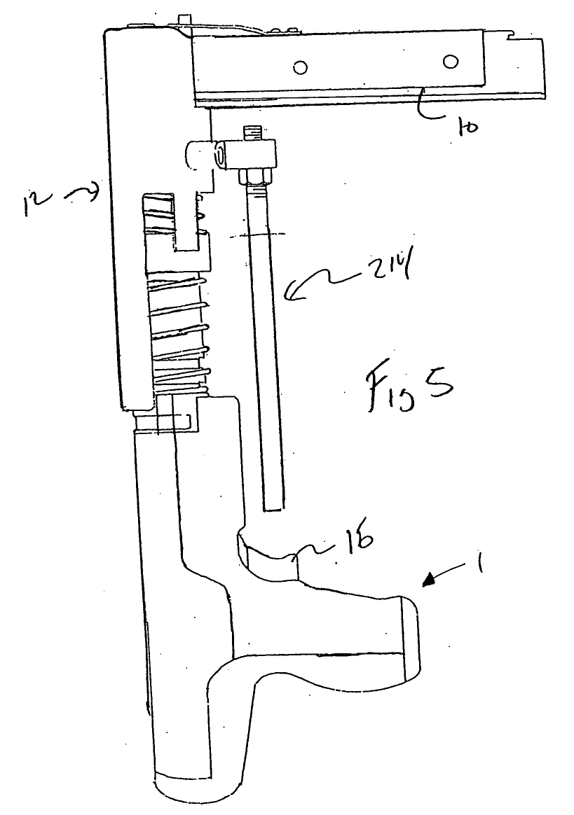

FIG. 7 illustrates a fastener assembly 120 having grooves or valleys 130 in the plate 124 and corresponding ridges or extending portions 138 therein, as well.

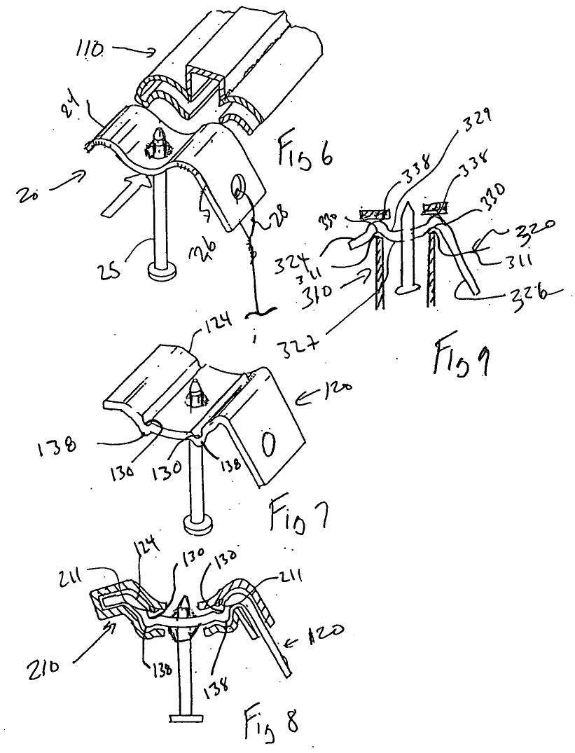

FIG. 8 illustrates the fastener assembly 120 placed within track 210. This fastener assembly 120 has extending portions 138 extending out of the plane of the plate 124 of the fastener assembly 120 that match with the contour of the track 210. This helps to guide the fastener assembly 110 down the track 210. The grooves 130 also help to align the fastener assembly 120 within the track 210, preventing jamming. Additionally, when the fastener assembly 120 is driven, the grooves 130 help the fastener assembly 120 to collapse assuring contact with a substrate. The grooves 130 may also help to prevent the fastener assembly from spinning once driven.

FIG. 9 illustrates a fastener assembly 320 in position on a track 310 in which a first side 327 of the plate 324 of the fastener assembly 320 contacts a pair of restricted plate contact areas 311 of the track 310 only at a pair of valleys or grooves 330 formed within the plate 324 of the fastener assembly 320. This makes possible a smaller width track 310 and assures that the leg portion 326 of the fastener assembly 320 does not inadvertently contact the track 310. For example, when the fastener assembly 320 is driven and the fastener assembly 320 collapses, the leg portion 326 of the fastener assembly 320 collapses, the leg portion 326 of the fastener assembly 320 may form substantially a right angle and bend inward towards the track 310. The narrower track 310 makes possible this bending without the fastener assembly 320 contacting the track 310. This prevent possible jamming within the feeding system. The track 310 also makes contact with a second side 329 of the plate 324 of the fastener assembly 320. As shown in FIG. 9, in the preferred form of the invention, when the fastener assembly plate 324 is formed with extending portions 338 as well as grooves 330, the track 310 only makes contact with the extending portions 338 on the second side 329 of the plate 324; however, the track could make contact with different portions of the plate 324 as well, and the plate 324 would still be guided smoothly in the track 310.

It should be appreciated that the fastener assembly 320 may be made in a variety of shapes without affecting the ability of the grooves or valleys 330 formed therein to engage or mate with restricted plate contact areas 311 of the track 310 and thereby guide the fastener assembly 320 in the track 310. Therefore, the plate 324 of the fastener assembly 320 may be flat, curved or raised or have other shapes.

As shown in FIG. 8, it should also be appreciated that restricted plate contact areas 211 can be formed in the track 210 to contact grooves or valleys 130 in the plate 124 of the fastener assembly 120, and yet the track 210 is contoured to make further contact with the plate 124 of the fastener assembly, such that the width of the track 210 at least on one side of the plate 124 of the fastener assembly is not particularly narrow.

Accordingly, it should be appreciated that the present invention greatly facilitates the automation of a power actuated gun 1 having a track 10 and a power actuated gun 1 that requires a trigger 16 to be pressed upon firing. Therefore, the power actuated gun 1 may be raised on a pole with the firing automated so that multiple fastener assemblies 20 may be placed within ceilings without lowering the power actuated gun 1. Additionally, a telescoping pole may be used and shortened so the power actuated gun 1 can be used without bending over when firing into the ground. The trigger actuating mechanism 14 is particularly advantageous when a track 10 is used to automatically feed fastener assemblies 20.

I claim:

1. A method of driving a fastener a fastener assembly comprising the steps of:
a. positioning a first fastener assembly having a nail frictionally received within a plate over the barrel portion of a power actuated gun;
b. depressing the barrel portion so that a trigger firing mechanism operatively connected to the barrel portion is lowered to contact a trigger of the power actuated gun;
c. further depressing the barrel portion of the power actuated gun so that trigger firing mechanism releases and pushes on the trigger of the power actuated gun, actuated the gun to drive the nail of the fastener assembly.

2. The method of claim 1, wherein:
the trigger firing mechanism is attached directly to the barrel portion of the power actuated gun.

3. The method of claim 1, wherein:
a. a fastener feeding track is attached to the barrel portion of the gun, the fastener feeding track carrying a plurality of the fastener assemblies; and
b. the trigger firing mechanism is attached directly to the fastener feeding track.

4. The method of claim 1, wherein:
the power actuated gun further comprises a spring that biases the barrel portion and track upward away from trigger of the power actuated gun.

5. The method of claim 4, wherein:
when the barrel portion is depressed the spring compresses and the trigger firing mechanism is lowered to contact the trigger.

6. The method of claim 1, wherein:
the trigger firing mechanism has a threaded member that allows for adjustment of the trigger firing mechanism.

7. A method of driving a fastener a fastener assembly comprising the steps of:
a. positioning a first fastener assembly having a nail frictionally received within a plate over the barrel portion of a power actuated gun;
b. depressing the barrel portion so that a trigger firing mechanism operatively connected to the barrel portion is lowered to contact a trigger of the power actuated gun, the trigger firing mechanism containing means for releasing upon contact with the trigger to fire the power actuated gun.

8. The method of claim 7, wherein:
the trigger firing mechanism is attached directly to the barrel portion of the power actuated gun.

9. The method of claim 7, wherein:
a. a fastener feeding track is attached to the barrel portion of the gun, the fastener feeding track carrying a plurality of the fastener assemblies; and
b. the trigger firing mechanism is attached directly to the fastener feeding track.

10. The method of claim 7, wherein:
the power actuated gun further comprises a spring that biases the barrel portion and track upward away from trigger of the power actuated gun.

11. The method of claim 10, wherein:
when the barrel portion is depressed the spring compresses and the trigger firing mechanism is lowered to contact the trigger.

12. The method of claim 7, wherein:
the trigger firing mechanism has a threaded member that allows for adjustment of the trigger firing mechanism.

13. A method of driving a fastener a fastener assembly comprising the steps of:
a. positioning a first fastener assembly having a nail frictionally received within a plate over the barrel portion of a power actuated gun, the power actuated gun having a trigger firing mechanism, the trigger firing mechanism having a pressure member that provides a slight constant pressure to the trigger by means of a spring;
b. depressing the barrel portion so that the trigger firing mechanism operatively connected to the barrel portion is lowered and applies sufficient pressure to a trigger of the power actuated gun to fire the power actuated gun.

14. The method of claim 13, wherein:
the trigger firing mechanism is attached directly to the barrel portion of the power actuated gun.

15. The method of claim 13, wherein:
a. a fastener feeding track is attached to the barrel portion of the gun, the fastener feeding track carrying a plurality of the fastener assemblies; and
b. the trigger firing mechanism is attached directly to the fastener feeding track.

16. The method of claim 13, wherein:
the power actuated gun further comprises a spring that biases the barrel portion and track upward away from trigger of the power actuated gun.

17. The method of claim 16, wherein:
when the barrel portion is depressed the spring compresses and the trigger firing mechanism is lowered to contact the trigger.

18. The method of claim 13, wherein:
the trigger firing mechanism has a threaded member that allows for adjustment of the trigger firing mechanism.

19. A power actuated gun for driving a first fastener assembly having a nail frictionally received within a plate, comprising:
a. a barrel portion having a trigger firing mechanism; and
b. a trigger, the trigger firing mechanism being operatively connected to the barrel portion so that when the barrel portion is lowered it contacts the trigger of the power actuated gun; actuating the power actuated gun.

20. The apparatus of claim 19, wherein:
the trigger firing mechanism is attached directly to the barrel portion of the power actuated gun.

21. The apparatus of claim 19, wherein:
a. a fastener feeding track is attached to the barrel portion of the gun, the fastener feeding track carrying a plurality of the fastener assemblies; and
b. the trigger firing mechanism is attached directly to the fastener feeding track.

22. The apparatus of claim 19, wherein:
the power actuated gun further comprises a spring that biases the barrel portion and track upward away from trigger of the power actuated gun.

23. The apparatus of claim 22, wherein:
when the barrel portion is depressed the spring compresses and the trigger firing mechanism is lowered to contact the trigger.

24. The apparatus of claim 19, wherein:
the trigger firing mechanism has a threaded member that allows for adjustment of the trigger firing mechanism.

25. A fastener assembly feeding system for use with a power actuated gun comprising:
a. a fastener assembly comprising a curved plate, and a stud frictionally held within the plate;
b. a track adapted to receive the curved plate, the track shaped to conform with the curved shape of the plate;
c. whereby a plurality of fastener assemblies are guided along the track.

26. The fastener assembly feeding system of claim 25, wherein:
the plate is additionally formed with a groove and the track is shaped to conform with the groove of the plate of the fastener assembly.

27. The fastener assembly feeding system of claim 25, wherein:
the plate is additionally formed with an extending portion and the track is shaped to conform with the extending portions of the plate of the fastener assembly.

28. A fastener assembly feeding system for use with a power actuated gun comprising:
a. a fastener assembly having a plate, the plate having a groove formed within the plate, and a stud frictionally held within the plate;
b. a track adapted to receive the plate, the track shaped to contact at least one side of the plate only in the groove;
c. whereby a plurality of fastener assemblies are guided along the track.

29. The fastener assembly feeding system of claim 28, wherein:
the plate has a pair of grooves, and the track is shaped to contact at least one side of the plate only at the grooves.
